(19) United States
(12) Patent Application Publication
(10) Pub. No.: US 2021/0044184 A1
(43) Pub. Date: Feb. 11, 2021

(54) WIRE HOLDER

(71) Applicant: Nidec Corporation, Kyoto (JP)

(72) Inventor: Pascual GUARDIOLA, Ingersheim (DE)

(21) Appl. No.: 16/967,756

(22) PCT Filed: Feb. 7, 2019
(86) PCT No.: PCT/IB2019/000012

§ 371 Date: Aug. 6, 2020

(30) Foreign Application Priority Data
Feb. 9, 2018 (DE) 10 2018 102 976.4

(51) Int. Cl. H02K 15/00; H02K 1/18; H02K 3/28

(52) U.S. Cl. CPC H02K 15/0068; H02K 3/28; H02K 1/185

(57) ABSTRACT

A wire holder for a stator of an electric motor includes a main body including a first wall portion and a second wall portion, and a partially annular clamp section which extends over 90° to 210° in a circumferential direction. The second wall portion defines an end surface of the clamp section and projects radially inwards, and includes at least two clamp sockets on the end surface and pointing away from the clamp section in an axial direction. The clamp sockets include at least one slot into which a winding connection wire can be laid.

### CROSS REFERENCE TO RELATED APPLICATIONS

This is a U.S. national stage of PCT Application No. PCT/IB2019/000012, filed on Feb. 7, 2019, and priority under 35 U.S.C. § 119(a) and 35 U.S.C. § 365(b) is claimed from German Application No. 102018102976.4, filed Feb. 9, 2018; the entire contents of which are incorporated herein by reference.

### 1. FIELD OF THE INVENTION

The present disclosure relates to a wire holder, an electric motor with a wire holder, and a method for manufacturing an electric motor.

### 2. BACKGROUND

In the case of electric motors, particularly brushless DC motors, a stator package is provided which is designed as a sheet metal package and which carried a number of wire coils to generate magnetic fields. The number of wire coils is often a multiple of 3 in electronically commutating motors. The wire coils are coiled in corresponding areas of the sheet metal package. The end of the copper wires used for this initially protrude from the stator package during manufacturing and are then connected to a connection area of the electric motor. The connection area is generally used to contact a switch which controls the electric motor.

In the prior art, the process of contacting the various coils of a stator package using sheet metal parts is, for example, known from DE 103 28 720 A1. The sheet metal parts are designed as stamped and bent parts and in this way can be manufactured in an inexpensive manner. The arrangement of these sheet metal parts on the stator package and the electrical and mechanical connection to the coils are costly and not suitable for all types of electric motors, particularly not for small motors.

### SUMMARY

Example embodiments of the present disclosure provide wire holders that each enable assembling of the wire holder on a stator package and assembling of winding wires in the wire holder to be achieved in a simple and durable manner.

Example embodiments of the present disclosure also provide electric motors each including a wire holder of this type, and methods of manufacturing electric motors including a wire holder.

Since in a wire holder for a stator of an electric motor a main body made of plastic including a first and a second wall portion is provided which has a partially annular clamp section which extends over 90° to 210° in a circumferential direction, wherein the second wall portion is on an end surface of the main body and which projects radially inwards, the wire holder can be placed on the external circumference of a stator package, positioned and held there. Since furthermore at least two clamp sockets are provided which are on the end surface and which die point away from the clamp section in an axial direction, wherein the clamp sockets in each case include at least one slot in which a wire can be laid, when manufacturing the electric motor the respective winding wire can be inserted into the clamp socket directly, in particular without any additional connection parts.

If the clamp sockets in each case have an inner space which is preferably channel-shaped and open on one side which is passed through by the slot, this inner space can be used for further electrical and/or mechanical connection with supply lines or circuit boards.

If the channel is further designed as guide for an insulation piercing contact, the electrical contact with the winding wire inserted inside is achieved by the simple insertion of an insulation piercing contact of this type into the inner space.

Particularly preferable geometric relationships are achieved if the slot is open in an axial direction pointing away from the clamp section, has a slot width which can be reduced in the direction on the clamp section and preferably the slot has a round, slotted hole which runs in an axial direction on its base. Then the winding wire can be inserted into the slot and held there. Furthermore, as a result of the clamping which occurs, the wire also holds the clamp section and therefore the entire wire holder in the intended position.

In a particular example embodiment of the present disclosure, the clamp section includes at least two snap-locking elements which extend radially inwards which are designed to engage in compatible recesses of the stator such that the wire holder can be held on the stator package in a locking manner.

A total of three clamp sockets are preferably provided, wherein each clamp socket can include more than one slot for the winding wires.

An electric motor according to another example embodiment of the present disclosure includes a wire holder designed as described above. If the wire holder is provided on an outer circumferential surface of the stator, this results in a particularly compact example embodiment which is easy to manufacture. This applies in particular if winding connection wires of the stator are inserted into the clamp sockets because these wires can then be held there and at the same time also secure the wire holder in its position on the stator package.

In order to do this, it is preferable if the winding connection wires run along a radial inner side of the wire holder and are angled radially outwards and at the position of the holes in the clamp socket and are inserted into said holes.

The wire holder is preferably fastened to the outer circumferential surface of the stator in a detachably fixed manner and held in an axial direction by the winding connection wires.

A method of manufacturing an electric motor according to an example embodiment of the present disclosure includes providing a stator package which includes at least two recesses on an outer circumferential surface and holds windings with winding connection wires that project beyond the stator package in an axial direction; placing a wire holder including slots onto the stator package in a radial direction such that the wire holder engages with snap-locking elements in the recesses and is held in a radial direction, wherein the winding connection wires are arranged radially; bending the winding connection wires outwards in a radial direction and laying each of the at least one winding connection wire in one of the slots of the wire holder; securing and contacting the winding wires by insulation piercing contacts on the winding connection wires in a transverse direction to sections of the winding connection wires located in the slots.

This simplifies the manufacturing while also making it particularly reliable.

The above and other elements, features, steps, characteristics and advantages of the present disclosure will become more apparent from the following detailed description of the example embodiments with reference to the attached drawings.

### BRIEF DESCRIPTION OF THE DRAWINGS

Example embodiments of the present disclosure are described below on the basis of the drawings, in which:

FIG. 1 shows a wire holder.

FIG. 2 shows the wire holder of FIG. 1 and a stator package before assembly.

FIG. 3 shows the components from FIG. 2 in an assembled condition.

FIG. 4 shows the assembly from FIG. 3 with winding connection wires and insulation piercing contacts inserted into the wire holder.

FIG. 5 shows an electric motor including a wire holder according to an example embodiment of the present disclosure.

### DETAILED DESCRIPTION

In the figures, identical or functionally identical components bear the same reference numbers.

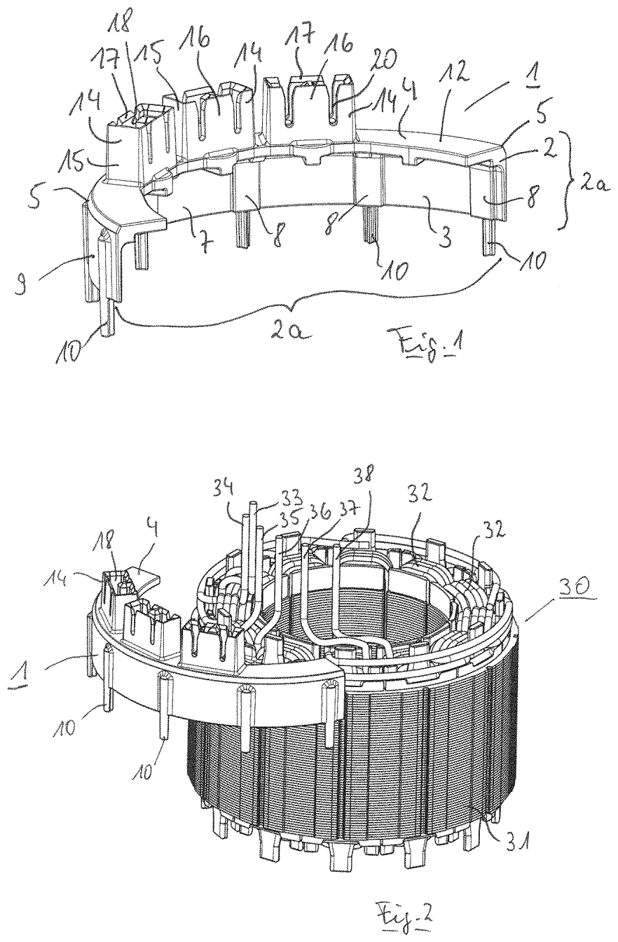

FIG. 1 is a perspective view of a wire holder 1. The wire holder 1 has a main body 2 having a clamp section 2a which extends in roughly the shape of an arc. A first wall part 3 is designed as a part of a cylinder mantle extending in an axial direction, while a second wall part 4 aligned in an axial direction points inwards at a right angle from the first wall part. Both wall parts 3 and 4 are connected to one another in one piece in the region of an outer edge 5 and form the clamp section 2a, which is to be arranged in a clampable manner on a stator package. The wire holder 1 is overall manufactured in one piece from a technical plastic in an injection moulding process.

On its inner side 7, the first wall part 3 which points radially inwards carries a number of reinforcement ribs 8. On an outer side 9 opposite the inner side 7, the first wall section carries a number of snap-locking elements 10 which are each arranged in the region of a reinforcement rib 8 such that a reinforcement rib 8 is allocated to each snap-locking element 10 on the inner side 7 arranged externally.

The second wall part 4 has a flat upper side 12 which extends in an essentially radial plane of the arrangement. A total of three clamp sockets 14 are formed on the upper side 12, wherein the clamp sockets 14 each have an approximately cuboid external shape which tapers slightly away from the upper side 12. The clamp sockets are limited by short side walls 15 and long side walls 16. The short side walls 15 and the long side walls 16 adjoin one another at approximately right angles and surround an inner space which is open on an upper side, wherein the upper side of the clamp socket 14 points away from the upper side 12 of the second wall part 4. Each of the upper edges of the short side walls and the longer side walls 16 has an insertion slant 17 which facilitates the insertion of connectors or the like into the inner space of the respective clamp socket 4.

The long side walls 16 are each passed through by two slots 20 running in parallel. The slots of the two opposite long side walls 16 are directly opposite one another so aligning the slots results in a passage opening which is oriented in a normal manner relative to the side walls 16. Each slot 20 extends from the upper edge of the long side wall 16 in an axial direction towards the second wall part 4 and ends at a distance from the upper side 12 of the second wall part 4. The clear width of the slot decreases.

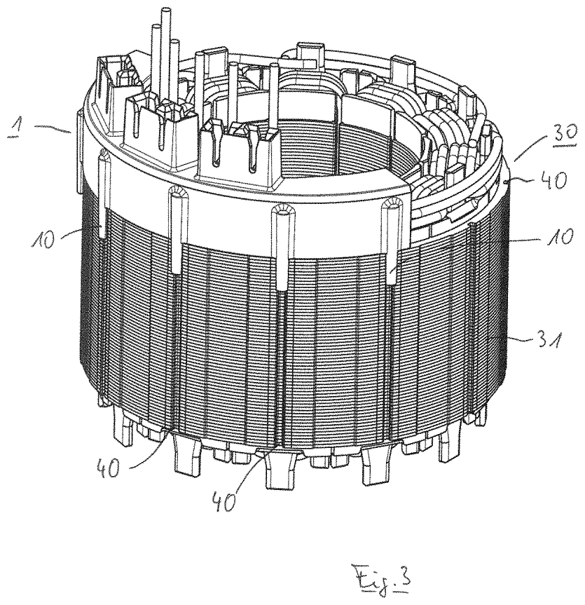

FIG. 2 shows the wire holder from FIG. 1 adjacent to a stator package 30. The wire holder 1 is in a position immediately before assembly on the stator package 30. The stator package 30 comprises, in a known manner, a plurality of sheet metal slats 31, which form the winding cores of wire coils 32 and in the subsequent function bundle the magnetic field formed by the flow of electricity through the winding package 32.

The winding packages 32 are normally made of a rigid copper wire which is varnished to ensure electrical insulation. The free ends of the wire coils form winding connection wires 33-38. The winding connection wires 33-38 lead out of the top of the stator package in the representation in FIG. 2 and point away from the winding packages in a manner which is essentially straight and parallel to the symmetrical axis of the stator package 30. The winding connection wires 33-38 are in a radial direction approximately in the region which forms the inner circumferential surface of the stator package 30 which surrounds the rotor when the electric motor is subsequently assembled.

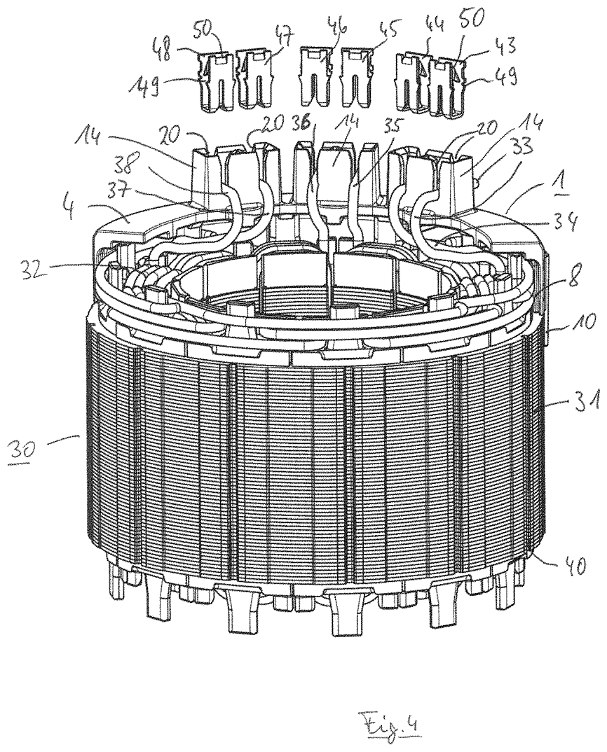

FIG. 3 shows the arrangement from FIG. 2, wherein the wire holder 1 is now placed on the stator package 30. On their outer circumference, the sheet metal slats 31 of the stator package 30 have a number of recesses 40 which extend inwards in a radial direction and which form grooves running in parallel to the axis on the outer circumferential surface of the stator package 30. The recesses 40 are evenly distributed over the circumference of the stator package 30, in other words they are arranged at a constant angular distance in the circumferential direction.

The wire holder 1 is placed on the stator package 30 such that a snap-locking element 10 of the wire holder 1 is inserted into a recess 40 of the stator package 30. Since the wire holder 1 extends over an angle range of around 160° in the circumferential direction of the stator package 30, the two external snap-locking elements, only one of which is visible here, are almost diametrically opposite one another. Since it is manufactured from a technical plastic, the clamp section 2a of the wire holder 1 has an elasticity which enables the snap-locking elements 10 to engage in the recesses 40 when the wire holder 1 is placed in the position shown in FIG. 3. The transfer of the wire holder 1 from the disassembled position shown in FIG. 2 to the assembled position shown in FIG. 3 in a radial direction of the arrangement is carried out such that the wire holder 1 is clipped onto the stator package 30. The axial position of the wire holder 1 is determined by the system of the ribs 8 on the upper side of the stator package 30 which is not visible in FIGS. 2 and 3, in other words on the upper surface of the sheet metal package 31. As a result, the wire holder 1 is positioned precisely in an axial direction and a radial direction relative to the stator package 30. The wire holder 1 is still not secured in an axial, upwards direction in FIG. 3.

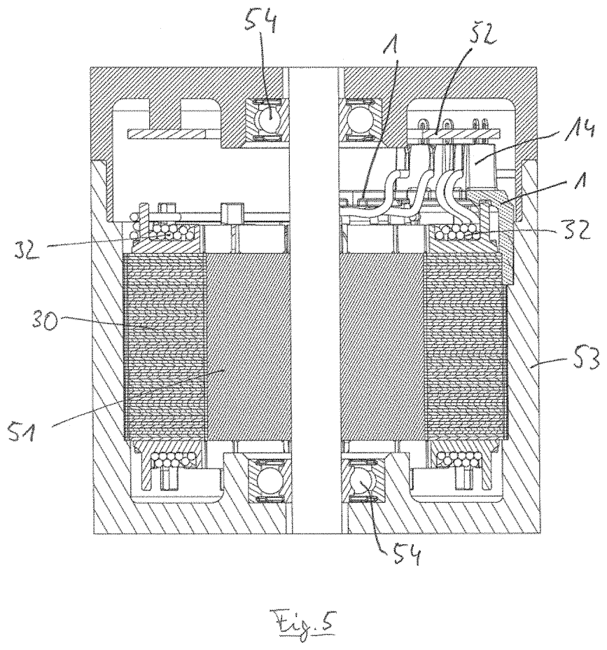

FIG. 4 shows the arrangement from FIG. 3 in a perspective view from another side. As described above, the wire holder 1 was placed on the stator package 30 where it is held by the snap-locking elements 10 which engage in the recesses 40. In this view, it is possible to see on the right-hand side that the reinforcement rib 8 protrudes on the upper sheet metal slat of the package 31, thereby defining the axial position of the wire holder 1 on the stator package 30. The second wall part 4, which extends in a radial plane of the arrangement, covers part of the winding packages 32 in the assembly position shown in FIG. 4.

Compared to the assembly condition of FIG. 3, the winding connection wires 33-38 in FIG. 4 are curved outwards in a radial direction and inserted into the respective slots of the three clamp sockets 14 far enough that the winding connection wires 33-38 lie on the closed end of the slots 20. The winding connection wires 33-38 pass through both slots 20 aligned with one another on the opposing long side walls 16 and the free ends protrude a small amount further radially outward beyond the outer surface of the clamp sockets 14. The winding connection wires 33-38 are relatively rigid and therefore now fix the wire holder 1 in an upwards direction in the axial direction of the arrangement too (away from the stator package 30). The width of the slot 20 which tapers downwards is slightly smaller at the lower end than the diameter of the winding connection wires 33-38 so the winding connection wires 33-38 are held in the slots 20 in a slightly clamped manner. In order to ensure better fixation, it is also possible to provide a round recess at the closed end of each slot 20 into which the respective wire can snap.

A number of insulation piercing contacts 43-48 are shown in FIG. 4 above the clamp socket 14. The insulation piercing contacts 43-48 are structurally identical and known to the person skilled in the art. In order to fix and connect the winding connection wires 33-38, the insulation piercing contacts 43-48 are inserted into the clamp sockets 14 from the position shown in FIG. 4 in an axial direction. Here they engage in an inextricable manner with barbs 49 and cut through the insulation on the winding connection wires 33-38. This means on the one hand the winding connection wires 33-38 are finally fastened into the clamp sockets 14 and on the other hand are brought into an electrically conductive connection with the insulation piercing contacts 43-48.

The upper side of the insulation piercing contacts 43-48 have a clamping area 50 in which further elements can be inserted for electrical contacting, for example electrical conductors in strip form, in sheet metal form or directly as printed circuit boards. With these elements, an electronic switch (not shown) to control the winding package 32 can be simply and reliably contacted with the winding connection wires 33-38.

The novel wire holder therefore enables simple, compact and reliable assembly on a stator package, a reliable hold of the winding connection wires 33-38 and a simple contacting of the wire connection wires 33-38 by means of insulation piercing contacts 43-48. The arrangement is to be manufactured in a compact and light manner with a small number of parts. The advantages mentioned also apply to an electric motor which is manufactured using a wire holder as described above.

An electric motor of this type is shown in cross-section in FIG. 5. The electric motor comprises the stator 30 having the winding packages 32, wherein the stator 30 carries the wire holder 1 (not fully identifiable here) having clamp sockets 14. The clamp sockets 14 are connected to a circuit board 52 to control the electric motor by means of the insulation piercing contacts 50.

A rotor 51 is rotatably mounted within the stator in a known manner. The arrangement is surrounded by a motor housing 53 which carries rolling bearings 54 for the rotatable mounting of the rotor 51. It is evident that the circuit board 52 is connected to the coils 32 by means of the insulation piercing contacts 50 in the region of the clamp sockets 14. As explained above, this reduces the number of parts and the electric motor is a compact and lightweight.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-13. (canceled)

14. A wire holder for a stator of an electric motor, the wire holder comprising:
a main body made of plastic including a first wall portion and a second wall portion including a partially annular clamp section extending over 90° to 210° in a circumferential direction, the second wall portion defining an end surface of the clamp section projecting radially inwards, and at least two clamp sockets on the end surface and pointing away from the clamp section in an axial direction; wherein
each of the clamp sockets includes at least one slot into which a winding connection wire is able to be laid.

15. The wire holder according to claim 14, wherein each of the at least two clamp sockets includes an inner space through which the slot extends.

16. The wire holder according to claim 15, wherein the inner space defines a guide for an insulation piercing contact.

17. The wire holder according to claim 14, wherein the at least one slot is open in an axial direction pointing away from the clamp section and includes a slot width that reduces towards the clamp section.

18. The wire holder according to claim 17, wherein the slot includes on a base thereof a circular slotted bore extending in a radial direction.

19. The wire holder according to claim 14, wherein the clamp section includes at least two snap-locking elements extending radially inwards to engage in recesses of the stator.

20. The wire holder according to claim 14, wherein a total of three clamp sockets are provided.

21. An electric motor comprising the wire holder according to claim 14.

22. The electric motor according to claim 21, wherein the wire holder is provided on an outer circumferential surface of the stator.

23. The electric motor according to claim 21, wherein winding connection wires of the stator are provided in the clamp sockets.

24. The electric motor according to claim 23, wherein the winding connection wires extend along a radial inner side of the wire holder and are angled radially outwards and located in the slots.

25. The electric motor according to claim 21, wherein the wire holder is detachably fixed in a snap-locking manner on an outer circumferential surface of the stator and is held in an axial direction by the winding connection wires.

26. A method for manufacturing an electric motor comprising:
providing a stator package including at least two recesses on an outer circumferential surface and holding windings with winding connection wires that project beyond the stator package in an axial direction;
placing a wire holder including slots onto the stator package in a radial direction such that the wire holder engages with snap-locking elements in the recesses to be held in a radial direction, the winding connection wires being radially inwards of the wire holder;
bending the winding connection wires outwards in a radial direction and laying each of the at least one winding connection wire in one of the slots of the wire holder; and
securing and contacting the winding wires by insulation piercing contacts on the winding connection wires in a transverse direction to sections of the winding connection wires located in the slots.
